(19) United States
(12) Patent Application Publication
(10) Pub. No.: US 2014/0275413 A1
(43) Pub. Date: Sep. 18, 2014

(54) HEAT AND MOISTURE RESISTANT ANAEROBIC ADHESIVES AND SEALANTS

(71) Applicant: DESIGNER MOLECULES, INC., San Diego, CA (US)

(72) Inventors: STEPHEN M. DERSHEM, SAN DIEGO, CA (US); JAMES T. HUNEKE, SAN DIEGO, CA (US); FARHAD G. MIZORI, SAN DIEGO, CA (US)

(73) Assignee: DESIGNER MOLECULES, INC., SAN DIEGO, CA (US)

(21) Appl. No.: 14/218,957

(22) Filed: Mar. 18, 2014

Related U.S. Application Data
(60) Provisional application No. 61/793,243, filed on Mar. 15, 2013.

(51) Int. Cl. C09J 133/10

(52) U.S. Cl. CPC C09J 133/10
USPC 524/706; 524/849; 524/850; 524/773

(57) ABSTRACT

Anaerobic adhesive compositions have been developed that are very thermally stable, and are also extremely hydrophobic to allow for formulations that can withstand extreme harsh temperature, pressure and moisture environments.

### CROSS REFERENCE TO RELATED APPLICATIONS

This application claims the benefit of priority under 35 USC §119 of U.S. Provisional Application Ser. No. 61/793,243 filed Mar. 15, 2013, the entire disclosure of which is incorporated herein by reference.

### FIELD OF INVENTION

The present invention provides anaerobic adhesive compositions that are able to withstand harsh conditions such as elevated temperatures and exposure to pressure and moisture at elevated temperatures. The compositions are based on free-radical curable ethylenically unsaturated functional groups on backbone that is very hydrophobic and less prone to hydrolysis under the conditions of high temperature, pressure and humidity.

### BACKGROUND OF INVENTION

Anaerobic adhesives constitute compounds that polymerize and harden when isolated from air between two adjacent faces, where it will serve to augment the seal or hold force of a mechanically joined assembly. Anaerobic adhesives are used as threadlockers, thread sealants, retaining materials and flange sealants. When designed into an assembly, these adhesives reduce component inventories, decrease total manufacturing costs and enhance equipment reliability.

Anaerobic adhesive is an adhesive of peculiar characteristics, while being liquid in the presence of air, these adhesives rapidly cure by polymerization if cut off from air in the state of a film in the gap at a screw or a fitting. Upon polymerization, the anaerobic adhesive forms a resin of dense three-dimensional, reticular structure, which has excellent anti-corrosiveness, solvent resistance, thermal resistance and aging resistance. Since no solvent is involved, the polymerization produces little contraction, to be suitable for fixing and sealing fitting, pipe and flange.

A typical nut-and-bolt assembly may have as little as 15% metal-to-metal contact. A fluid anaerobic threadlocker material can fill the air voids between the thread roots and cure into a hard thermoset plastic to provide a unitized assembly.

Historically, anaerobic adhesives have used a variety of commercially available acrylates or methacrylates as the base resin to undergo polymerization. The additional compounds are added to the formulation to cause the material to undergo polymerization and form a hard three-dimensional polymer with very high shear strength. Among these additives are typically an organic peroxide initiator and accelerator. In order to get an anaerobic adhesive to polymerize one has to exclude oxygen from the adhesive, another criteria is that the adhesive must come into contact with a metal ion such as iron or copper that will aid in decomposing the organic peroxide. A criterion that is often overlooked is temperature, as with any reaction the higher the temperature the faster the reaction proceeds. Typically, anaerobic adhesives are applied at room temperature, and may require an hour to two to reach a usable strength, and often require up to 24 hours to reach the maximum strength, and much of this is dependent on the temperature of the environment.

Many companies offer anaerobic adhesives that are rated at different strengths, and allow the formulation to provide adequate adhesion at different temperatures from well below freezing to above 200° C.

The limitation to these anaerobic adhesives is that they very quickly fail in environments that are also very humid or under water applications that require high temperature and pressure.

### BRIEF DESCRIPTION OF INVENTION

The anaerobic adhesive and sealants of the invention are based on a variety of curable ethylenically unsaturated functional groups attached to very hydrophobic and thermally stable backbones. The functional groups include, maleimides, citraconimides, acrylates, methacrylates, vinyl ethers, vinyl esters, acrylamides, methacrylamides, as well as allyl and styrenyl compounds.

The backbone, which is the critical part of the invention and allows the adhesive to withstand the harsh conditions, is often derived from very hydrophobic aliphatic aromatic or polycyclic materials. In formulating an anaerobic adhesive that will survive harsh conditions of well over 200° C., with high pressure, and high humidity, it is crucial to have all of the starting material to be as hydrophobic as possible. The organic resins should also be composed of compounds that have linkages that are stable at high temperatures and are less prone to hydrolysis.

Examples of the curable polyolefinically unsaturated class of compounds that is suitable as a base resin in the practice of the invention are the polyester acrylate methacrylate resins, and maleimide terminated polyimide resins (both of Designer Molecules, Inc., San Diego, Calif.). These compounds have already been proven in high temperature applications as die-attach adhesives, coatings, and in applications such as oil exploration down-hole coatings for sensitive electronics devices.

The desirable features of these resins are that they are able to withstand very high temperatures of over 200° C. for prolonged periods of time without undergoing any thermal degradation. The other feature that is crucial is that they typically absorb less than 1% moisture at 85° C. and 85% relative humidity over 168 hours, which is the electronics industry standard. Furthermore the maleimide-terminated polyimides have been shown to absorb less than 1.5% moisture even when the cured sample was placed in water at 200° C. over five days.

Those skilled in the art know that even if one has hydrophilic components in the formulation such as peroxide initiators, accelerators, pigments, and such as long as the base resin is hydrophobic enough it will act as a barrier and prevent moisture from penetrating into the cured matrix and causing hydrolysis, and loss of adhesion.

### DETAILED DESCRIPTION OF THE INVENTION

Unless specific definitions are provided, the nomenclatures utilized in connection with, and the laboratory procedures and techniques of analytical chemistry, synthetic organic and inorganic chemistry described herein are those known in the art, such as those set forth in “IUPAC Compendium of Chemical Terminology: IUPAC Recommendations (The Gold Book)” (McNaught ed.; International Union of Pure and Applied Chemistry, 2^{nd} Ed., 1997) and “Compendium of Polymer Terminology and Nomenclature: IUPAC Recommendations 2008” (Jones et al., eds; International Union of Pure and Applied Chemistry, 2009). Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

### DEFINITIONS

“About” as used herein means that a number referred to as “about” comprises the recited number plus or minus 1-10% of that recited number. For example, “about” 100 degrees can mean 95-105 degrees or as few as 99-101 degrees depending on the situation. Whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms (although the term “alkyl” also includes instances where no numerical range of carbon atoms is designated).

“Adhesive” or “adhesive compound” as used herein, refers to any substance that can adhere or bond two items together. Implicit in the definition of an “adhesive composition” or “adhesive formulation” is the fact that the composition or formulation is a combination or mixture of more than one species, component or compound, which can include adhesive monomers, oligomers, and/or polymers along with other materials, whereas an “adhesive compound” refers to a single species, such as an adhesive polymer or oligomer.

More specifically, adhesive composition refers to un-cured mixtures in which the individual components in the mixture retain the chemical and physical characteristics of the original individual components of which the mixture is made. Adhesive compositions are typically malleable and may be liquids, paste, gel or another form that can be applied to an item so that it can be bonded to another item.

“Cured adhesive,” “cured adhesive composition” or “cured adhesive compound” refers to adhesives components and mixtures obtained from reactive curable original compound(s) or mixture(s) thereof which have undergone a chemical and/or physical changes such that the original compound(s) or mixture(s) is (are) transformed into a solid, substantially non-flowing material. A typical curing process may involve crosslinking.

“Curable” means that an original compound(s) or composition material(s) can be transformed into a solid, substantially non-flowing material by means of chemical reaction, crosslinking, radiation crosslinking, or the like. Thus, adhesive compositions of the invention are curable, but unless otherwise specified, the original compound(s) or composition material(s) is (are) not cured.

“Thermoset,” as used herein, refers to the ability of a compound, composition or other material to irreversibly “cure” resulting in a single three-dimensional network that has greater strength and less solubility compared to the non-cured product. Thermoset materials are typically polymers that may be cured, for example, through heat (e.g. above 200° Celsius), via a chemical reaction (e.g. epoxy ring-opening, free-radical polymerization, etc.), or through irradiation (e.g. visible light, U.V., or X-ray irradiation).

Thermoset materials, such as thermoset polymers or resins, are typically liquid or malleable forms prior to curing, and therefore may be molded or shaped into their final form, and/or used as adhesives. Curing transforms the thermoset resin into a rigid infusible and insoluble solid or rubber by a cross-linking process. Thus, energy and/or catalysts are typically added that cause the molecular chains to react at chemically active sites (unsaturated or epoxy sites, for example), linking the polymer chains into a rigid, 3-D structure. The cross-linking process forms molecules with a higher molecular weight and resultant higher melting point. During the reaction, when the molecular weight of the polymer has increased to a point such that the melting point is higher than the surrounding ambient temperature, the polymer becomes a solid material.

“Cross-linking,” as used herein, refers to the attachment of two or more oligomer or longer polymer chains by bridges of an element, a molecular group, a compound, or another oligomer or polymer. Crosslinking may take place upon heating; some crosslinking processes may also occur at room temperature or a lower temperature. As cross-linking density is increased, the properties of a material can be changed from thermoplastic to thermosetting.

The term “monomer” refers to a molecule that can undergo polymerization or copolymerization thereby contributing constitutional units to the essential structure of a macromolecule (a polymer).

“Polymer” and “polymer compound” are used interchangeably herein, to refer generally to the combined the products of a single chemical polymerization reaction. Polymers are produced by combining monomer subunits into a covalently bonded chain. Polymers that contain only a single type of monomer are known as “homopolymers,” while polymers containing a mixture of monomers are known as “copolymers.”

As used herein, “aliphatic” refers to any alkyl, alkenyl, cycloalkyl, or cycloalkenyl moiety.

“Aromatic hydrocarbon” or “aromatic” as used herein, refers to compounds having one or more benzene rings.

“Alkane,” as used herein, refers to saturated straight-chain, branched or cyclic hydrocarbons having only single bonds. Alkanes have general formula CₙH₂ₙ₊₂.

“Cycloalkane,” refers to an alkane having one or more rings in its structure.

As used herein, “alkyl” refers to straight or branched chain hydrocarbyl groups having from 1 up to about 500 carbon atoms. “Lower alkyl” refers generally to alkyl groups having 1 to 6 carbon atoms. The terms “alkyl” and “substituted alkyl” include, respectively, substituted and unsubstituted C₁-C₅₀₀ straight chain saturated aliphatic hydrocarbon groups, substituted and unsubstituted C₂-C₂₀₀ straight chain unsaturated aliphatic hydrocarbon groups, substituted and unsubstituted C₄-C₁₀₀ branched saturated aliphatic hydrocarbon groups, substituted and unsubstituted C₁-C₅₀₀ branched unsaturated aliphatic hydrocarbon groups.

“Substituted alkyl” refers to alkyl moieties bearing substituents that include but are not limited to alkyl, alkenyl, alkynyl, hydroxy, oxo, alkoxy, mercapto, cycloalkyl, substituted cycloalkyl, heterocyclic, substituted heterocyclic, aryl, substituted aryl (e.g., arylC₁₋₁₀alkyl or arylC₁₋₁₀alkyloxy), heteroaryl, substituted heteroaryl (e.g., heteroarylC₁₋₁₀alkyl), aryloxy, substituted aryloxy, halogen, haloalkyl (e.g., trihalomethyl), cyano, nitro, nitrone, amino, amido, carbamoyl, ═O, ═CH—, —C(O)H, —C(O)O—, —C(O)—, —S—, —S(O)₂—, —OC(O)—O—, —NR—C(O)—, —NR—C(O)—NR—, —OC(O)—NR—, where R is H or lower alkyl, acyl, oxyacyl, carboxyl, carbamate, sulfonyl, sulfonamide, sulfuryl, C₁₋₁₀alkylthio, arylC₁₋₁₀alkylthio, C₁₋₁₀alkylamino, arylC₁₋₁₀alkylamino, N-aryl-N—C₁₋₁₀alkylamino, C₁₋₁₀ alkyl carbonyl, arylC₁₋₁₀alkylcarbonyl, C₁₋₁₀alkylcarboxy, aryl C₁₋₁₀alkylcarboxy, C₁₋₁₀ alkyl carbonylamino, aryl C₁₋₁₀alkylcarbonylamino, tetrahydrofuryl, morpholinyl, piperazinyl, and hydroxypyronyl.

In addition, as used herein “C₃₆” refers to all possible structural isomers of a 36 carbon aliphatic moiety, including branched isomers and cyclic isomers with up to three carbon-carbon double bonds in the backbone. One non-limiting example of a moiety that the definition of “C₃₆” refers to is the moiety comprising a cyclohexane-based core and four long “arms” attached to the core, as demonstrated by the following structure:

[chemical structure]

As used herein, “cycloalkyl” refers to cyclic ring-containing groups containing in the range of about 3 up to about 20 carbon atoms, typically 3 to about 15 carbon atoms. In certain embodiments, cycloalkyl groups have in the range of about 4 up to about 12 carbon atoms, and in yet further embodiments, cycloalkyl groups have in the range of about 5 up to about 8 carbon atoms, and “substituted cycloalkyl” refers to cycloalkyl groups further bearing one or more substituents as set forth below.

As used herein, the term “aryl” represents an unsubstituted, mono-, di- or trisubstituted monocyclic, polycyclic, biaryl aromatic groups covalently attached at any ring position capable of forming a stable covalent bond, certain preferred points of attachment being apparent to those skilled in the art (e.g., 3-phenyl, 4-naphtyl and the like).

As used herein, “hetero” refers to groups or moieties containing one or more heteroatoms such as N, O, Si, P and S. Thus, for example “heterocyclic” refers to cyclic (i.e., ring-containing) groups having e.g. N, O, Si, P or S as part of the ring structure, and having in the range of 3 up to 14 carbon atoms. “Heteroaryl” and “heteroalkyl” moieties are aryl and alkyl groups, respectively, containing e.g. N, O, Si, P or S as part of their structure. The terms “heteroaryl”, “heterocycle” or “heterocyclic” refer to a monovalent unsaturated group having a single ring or multiple condensed rings, from 1 to 8 carbon atoms and from 1 to 4 hetero atoms selected from nitrogen, sulfur or oxygen within the ring.

Hetero-containing groups may also be substituted. For example, “substituted heterocyclic” refers to a ring-containing group having in the range of 3 up to 14 carbon atoms that contains one or more heteroatoms and also bears one or more substituents, as set forth above.

As used herein, the term “phenol” includes compounds having one or more phenolic functions per molecule. The terms aliphatic, cycloaliphatic and aromatic, when used to describe phenols, refers to phenols to which aliphatic, cycloaliphatic and aromatic residues or combinations of these backbones are attached by direct bonding or ring fusion.

As used herein, “alkenyl,” “alkene” or “olefin” refers to straight or branched chain unsaturated hydrocarbyl groups having at least one carbon-carbon double bond, and having in the range of about 2 up to 500 carbon atoms. “Substituted alkenyl” refers to alkenyl groups further bearing one or more substituents as set forth above.

As used herein, “alkylene” refers to a divalent alkyl moiety, and “oxyalkylene” refers to an alkylene moiety containing at least one oxygen atom instead of a methylene (CH₂) unit. “Substituted alkylene” and “substituted oxyalkylene” refer to alkylene and oxyalkylene groups further bearing one or more substituents as set forth above.

As used herein, “acyl” refers to alkyl-carbonyl species.

“Allyl” as used herein, refers to refers to a compound bearing at least one moiety having the structure:

[chemical structure]

“Imide” as used herein, refers to a functional group having two carbonyl groups bound to a primary amine or ammonia.

“Polyimides” are polymers of imide-containing monomers. Polyimides are typically linear or cyclic. Non-limiting examples of linear and cyclic (e.g. an aromatic heterocyclic polyimide) polyimides are shown below for illustrative purposes.

[chemical structure]

“Maleimide,” as used herein, refers to an N-substituted maleimide having the formula as shown below:

[chemical structure]

where R is an aromatic, heteroaromatic, aliphatic, or polymeric moiety.

“Bismaleimide” or “BMI”, as used herein, refers to compound in which two imide moieties are linked by a bridge, i.e. a compound a polyimide having the general structure shown below:

[chemical structure]

where R is an aromatic, heteroaromatic, aliphatic, or polymeric moiety.

BMIs can cure through an addition rather than a condensation reaction, thus avoiding problems resulting from the formation of volatiles. BMIs can be cured by a vinyl-type polymerization of a pre-polymer terminated with two maleimide groups.

As used herein, the term “acrylate” refers to a compound bearing at least one moiety having the structure:

[chemical structure]

As used herein, the term “acrylamide” refers to a compound bearing at least one moiety having the structure:

[chemical structure]

As used herein, the term “methacrylate” refers to a compound bearing at least one moiety having the structure:

[chemical structure]

As used herein, the term “methacrylamide” refers to a compound bearing at least one moiety having the structure:

[chemical structure]

As used herein, “maleate” refers to a compound bearing at least one moiety having the structure:

[chemical structure]

As used herein, the term “citraconimide” refers to a compound bearing at least one moiety having the structure:

[chemical structure]

“Itaconate”, as used herein refers to a compound bearing at least one moiety having the structure:

[chemical structure]

As used herein, the terms “halogen,” “halide,” or “halo” include fluorine, chlorine, bromine, and iodine.

As used herein, “siloxane” refers to any compound containing a Si—O moiety. Siloxanes may be either linear or cyclic. In certain embodiments, siloxanes of the invention include 2 or more repeating units of Si—O. Exemplary cyclic siloxanes include hexamethylcyclotrisiloxane, octamethylcyclotetrasiloxane, decamethylcyclopentasiloxane, dodecamethylcyclohexasiloxane and the like.

As used herein, the term “vinyl ether” refers to a compound bearing at least one moiety having the structure:

[chemical structure]

As used herein, the term “vinyl ester” refers to a compound bearing at least one moiety having the structure:

[chemical structure]

As used herein, “styrenic” refers to a compound bearing at least one moiety having the structure:

[chemical structure]

“Fumarate” as used herein, refers to a compound bearing at least one moiety having the structure:

[chemical structure]

As used herein, the term “free radical initiator” refers to any chemical species which, upon exposure to sufficient energy (e.g., light, heat, or the like), decomposes into parts, which are uncharged, but every one of such part possesses at least one unpaired electron.

As used herein, the term “coupling agent” refers to chemical species that are capable of bonding to a mineral surface and which also contain polymerizably reactive functional group(s) so as to enable interaction with the adhesive composition. Coupling agents thus facilitate linkage of the die-attach paste to the substrate to which it is applied.

As used herein, the term “anaerobic adhesive” refers to an adhesive that remains fluid in the presence of oxygen, but undergoes a polymerization in the absence of oxygen.

As used herein, the term “threadlocker” or “thread-locking fluid” refers to a single-component, or a single-component plus a primer, anaerobic adhesive, applied to the threads of fasteners such as screws and bolts to prevent loosening, leakage, and corrosion.

As used herein, the term “primer” refers to a coating that is applied to the surfaces to be bonded to provide further adhesion, and often in the case of the present invention, the primer coating contains the activators and or hydroperoxide decomposers that will allow for the anaerobic adhesive to cure properly.

### EMBODIMENTS OF INVENTION

Search and testing of the highest performance anaerobic adhesives products on the market reveals a shortcoming with all of these products. These products do perform as advertised, and are quality products for high temperature applications as threadlockers. Even at elevated temperatures over 200 OC the products retain very high strength over time. However, when these products are exposed to a combination of high temperature, pressure, and moisture, the adhesion drops quickly and severely. High temperature, moisture and pressure are conditions that are found in equipment that is used in drilling, undersea explorations, on naval and marine craft and equipment, although we do not wish to be limited by these simple examples, the adhesives are in fact well suited for use in most adhesive applications.

In order to prevent significant loss of adhesion of an anaerobic adhesive exposed to a combination of high temperature, pressure and moisture one skilled in the art would have to take special precautions to exclude components that have weak links that may decompose thermally, or are prone to hydrolysis.

Those skilled in the art also know that even if the linkages are hydrolytically stable, the resin itself may be very hydrophilic and readily absorb moisture, which would compromise the adhesive bond. Typically, compounds derived from polyethylene glycol, polypropylene glycol, and derivatives thereof are known to absorb large amounts of moisture. Those skilled in the art understand that organic molecules that are soluble in water typically contain polar groups, or groups that are subject to hydrogen bonding. Therefore, the moisture uptake of a cured resin is going to depend in large part on the relative percentage of the molecular weight that is hydrocarbon compared to the relative percentage that is heteroatom (oxygen, nitrogen, sulfur, phosphorous). Typically, as the percent heteroatom gets below 25% the resin will have better performance in moist conditions. As the percent heteroatom gets to about 20% the material will typically pass the 85/85 testing. In order to pass the high temperature and moisture such as in a Parr bomb, it is desirable to have the percent heteroatom to be well below 20% as well as eliminating any hydrolytically prone linkages.

A series of very hydrophobic compounds derived from the thermal oligomerization of C-18 unsaturated fatty acids such as oleic acid and linoleic acid from natural oils are commercially available starting materials (Croda, East Yorkshire, England). These typically C-36 also may contain small amounts of C-54 compounds called dimer and trimer fatty acids and all of its derivatives, dimer diol, dimer diamine, and dimer di-isocyanate form what are very hydrophobic starting materials for many of the curable resins of the invention formulas. Combinations of the dimer species above with various other compounds will also produce a variety of polyesters, polyamides, polyimides, polyethers, polyurethanes, polyureas, and combinations thereof. The oligomer or polymer can be functionalized with an ethylenically unsaturated group that is capable of undergoing polymerization.

Some of the examples of such molecules are described as follows, however, we wish not to be limited by the following examples. These compounds are derived from a series of naturally occurring fatty acids that are dimerized at high temperature, hence the term dimer acid. The dimer acid can then be further modified to produce dimer diol, dimer diamine, and dimer acid diisocyanate. The materials are available either as the saturated or unsaturated compounds, all of which are contemplated for use in the practice of the invention.

[chemical structure]

[chemical structure]

[chemical structure]

[chemical structure]

wherein, R is either H or methyl.

The bismaleimide of dimer diamine (Priamine-1074, Croda or Versamine-551, BASF) has some unsaturation remaining on the C-36 backbone, this material is referenced as UX-BMI. The bismaleimides of dimer diamine (Priamine-1075, Croda or Versamine-552, BASF) has very little remaining unsaturation on C-36 backbone, this material is referenced as X-BMI. Both the UX-BMI and the X-BMI are low viscosity, hydrophobic resins. The heteroatom percentage (O, N) in these molecules is approximately 13% based on the total molecular weight of the molecule.

Some other very hydrophobic diol compounds also are commercially available, such as decanediol, dodecanediol, tricyclodecane diol, and alike, these compounds are readily converted to the acrylate or methacrylate to provide very hydrophobic, low viscosity diluents to go into the formulation.

In another embodiment of the invention other reactive diluents can be used bring the viscosity of the product to within a certain specification. Such diluents include but are not limited to mono-, di-, tri- and poly-functional acrylates, methacrylates, vinyl ethers, and such that are commercially available (Sartomer, Exton, Pa.).

In another embodiment of the invention the very hydrophobic and thermally stable polyester acrylate methacrylate compounds (Designer Molecules, Inc., San Diego, Calif.) are used as the base resin in an anaerobic adhesive. These compounds are described in U.S. Pat. No. 7,285,613 (Dershem, et al.), U.S. Pat. No. 7,786,234 (Dershem, et al.), and U.S. Pat. No. 7,875,688 (Dershem, et al.), all of which are herein incorporated by reference.

[chemical structure]

In yet another embodiment of the invention the very hydrophobic and thermally stable maleimide-terminated polyimide compounds as well as other ethylenically unsaturated polyimide compounds (Designer Molecules, Inc., San Diego, Calif.) are used as the base resin in an anaerobic adhesive. These compounds are described in U.S. Pat. No. 7,157,587 (Mizori, et al.), U.S. Pat. No. 7,208,566 (Mizori, et al.), and U.S. Pat. No. 7,884,174 (Mizori, et al.), and all of which are herein incorporated by reference.

[chemical structure]

wherein, R is hydrogen or methyl, R2 is strait or branched aliphatic, aromatic, substituted aromatic, siloxane, cycloaliphatic, polycyclic; Q is chosen from groups that are aromatic, heteroaromatic, aliphatic, siloxane, polycyclic. Many of the maleimide terminated polyimides are materials that make very good films, so these materials are ideal for use in the semi-solid glue stick type anaerobic adhesive, or they may be processed and wound into a tape form of the adhesive. The addition of a small amount of a polyamide based compound to a low viscosity formulation will also cause gel formation leading to a non-flowable anaerobic adhesive formulation is so desired.

In yet another embodiment of the invention hydrophobic polyester polyols such as Priplast™ (Croda, East Yorkshire, England) derived from the dimerization of natural fatty acids are converted to the acrylate, methacrylate, vinyl ether, itaconates, maleates, maleimide esters and other curable compounds and used in the invention.

In yet another embodiment of the invention hydrophobic hydroxyl-terminated polybutadienes are commercially available from various sources (Cray Valley, Exton, Pa.), (Nippon Soda Chemical Company, Tokyo, Japan) these compounds can be either primary or secondary alcohol, the molecular weight varies from very a few hundred up to over 3000 molecular weight. These materials can be derived from the 1,2 and 1,4 polymerization of butadiene or combination thereof. These materials are also available as the polyolefin or they can be acquired as the hydrogenated resins. These compounds have been converted to the various acrylate, methacrylates, vinyl ethers, itaconates, maleates, maleimide esters, citraconimide esters, and used as anaerobic adhesives. Also available are the maleated polybutadienes, and the epoxidized polybutadienes, which may also be incorporated in the adhesives as co-reactants or adhesion promoters.

[chemical structure]

In conjunction with the hydrophobic base resins, the anaerobic adhesive formulation is going to require the use of certain peroxide compounds to start the initiator. The free-radical initiators contemplated for use in the practice of the invention include but are not limited to organic peroxides and hydroperoxides commercially available. These include, cumene hydroperoxide, p-menthane hydroperoxide, t-butyl hydroperoxide, diisopropylbenzene hydroperoxide, pinene hydroperoxide, methyl ethyl ketone hydroperoxide, t-butyl perbenzoate, and the like. The amount of peroxide initiator contemplated for use in the invention formulation typically will range from 0.1 wt % to about 10-wt %.

In another embodiment of the invention one or more surface activators are added to the anaerobic adhesive formulation to allow the cure to occur at a reasonable speed in the absence of oxygen. Not wishing to be bound by any one theory the surface activators, which may include all transition metals, the transition metal oxides, transition metal sulfur compounds, transition metal carboxylates, transition metal ions, organometallic complexes, such as those of nickel, iron, cobalt, copper, zinc, chromium, manganese, platinum, silver, titanium and the like. These transition metal complexes are known to those skilled in the art as hydroperoxide decomposers. Alternatively, in another embodiment of the invention the surface activator can be used separately as a primer to be applied to the parts to be joined followed by the application of the anaerobic adhesive. The contact of any hydroperoxides in the anaerobic adhesive formulation with the primer in the absence of oxygen will cause a redox reaction and the gelation and ultimately cure of the resin into a solid polymer.

Certain other accelerators may be added to the formulation which also are knows to those skilled in the art to decompose peroxides. Examples include, but are not limited to compounds such as, N,N-dihydroxyethyl-p-toluidine, N,N-dimethyl-p-toluidine, and many other amine type compounds, saccharin, pyrollidones, acrylamides, methacrylamides, hydrazines, maleic acid, maleimidoacids, meth(acrylic) acid, compounds containing urea, urethane, amide linkages, aldehydes and such. The cure accelerators may be added to the anaerobic formulation itself or they may be used as a separate primer applied to the substrate prior to the anaerobic adhesive.

In order to prevent the anaerobic adhesive from curing prematurely and to give the product shelf life free-radical inhibitors are also contemplated for use in the invention formulations. These inhibitors include but are not limited to examples, such as; butylated hydroxytoluene (BHT), p-methoxyphenol, hydroquinone, benzoquinone, naphthoquinone, phenyl benzoquinone, dichlorobenzoquinone, TEMPO, and such, or combinations thereof. Often it may also be necessary to add a soluble chelating compound such as tetrasodium salt of ethylene diamine tetraacetic acid to help stabilize the formulation from trace metal contaminants. It is contemplated that the inhibitor level and chelating compound can range from 0.001 weight percent (wt %) up to 1 wt % based on the total weight of the formulation.

The invention anaerobic adhesive formulations vary in viscosity according to the use and type of application. In one embodiment of the invention low viscosity, fluid formulations are contemplated in the invention, where the material can flow easily and penetrate very hard to reach areas that require adhesion or protection from the environment. In another embodiment of the invention the formulation is very high viscosity, or semi-solid and would be applied, as would a glue stick to the parts to be joined. In yet another embodiment of the invention, the product formulation is a solid with very good film forming capability and would be wound and used in the form of a tape.

It is known to those skilled in the art that in order to change the viscosity or thixotropy of a certain formulation often modifiers are added to the formulation. Certain well-known polymers such as polymethyl methacrylate, butadiene-styrene, cellulose esters, acrylonitrile-butadiene-styrene, polyvinyl chloride, polyesters, nylon, polyimides, polyvinyl acetate, polyurethanes, polyureas, polyethers, and certain other thermoplastics can be added to the formulation to control the flow characteristics.

Also contemplated for the invention is the use of fillers to control viscosity and rheology of the formula. Fillers contemplated for use include, but are not limited to silica, boron nitride, graphite, aluminum nitride, silicon carbide, diamond dust, and the like. Compounds, which act primarily to modify rheology, include polysiloxanes, silica, fumed silica, fumed alumina, fumed titanium dioxide, calcium carbonate, and the like.

Various aromatic and aliphatic solid bismaleimides resins are also commercially available, these compounds are not as hydrophobic, however, these materials are also contemplated for use in the invention is small percentages to change the viscosity or the glass transition temperature of the formulation.

In one embodiment the invention anaerobic adhesives can be used as threadlocking adhesive or sealant to provide adhesion and protection from the environment to a nut-and-bolt assembly, or pipe connections. In another embodiment the invention formulations can be used as retaining compound for rigid non-threaded cylindrical assemblies, such as joining a bearing onto a shaft, sealing of cup plugs, and oil seals in castings. In yet another embodiment the invention anaerobic adhesives can be used as gasketing materials for use as formed-in-place gaskets that produce leak-proof seals between mating flanges, preventing leakage of moisture, gasses, fluids or contaminants. In yet another embodiment the invention anaerobic adhesives can be used for bonding structural components. In still another embodiment the invention anaerobic adhesives can be used in sealing flange joints, sealing porous metal castings, welds, and powdered metal parts.

### Examples

### Example 1

### Formula A

An anaerobic adhesive formulation was prepared by mixing 88 wt % PEAM-1044 (polyester acrylate methacrylate) with 4 wt %/o saccharin, 4 wt/o cumene hydroperoxide, and 4 wt % N,N-diethyl-p-toluidine.

### Example 2

### Formula B

An anaerobic adhesive formulation was prepared by mixing 92 wt % hydrogenated aliphatic bismaleimides (X-BMI), 4 wt % saccharin, and 4 wt % cumene hydroperoxide.

### Example 3

### Formula C

An anaerobic adhesive formulation was prepared by mixing 92 wt % unsaturated aliphatic bismaleimides (UX-BMI), 4 wt % saccharin, and 4 wt/o cumene hydroperoxide.

The formulations were used as anaerobic adhesive, specifically as threadlocker adhesive for a nut-and-bolt assembly. For comparative purposes the formulations were compared to Loctite 272 threadlocker, a material that is rated for 232° C. (450 OF) and highest adhesion.

Standard nut-and-bolt assemblies were prepared by washing and drying them thoroughly. Series of primers were applied to the threads, followed by the application of the threadlocker. The nuts-and-bolts were assembled and hand tightened with a wrench.

The parts were allowed at least four days at room temperature to allow for full cure.

The assembled parts were tested for initial breakaway Torque; all of the nut-and-bolt assemblies were then placed in a Parr pressure vessel filled with deionized water. The temperature of the vessel was maintained at 220° C. and 405 psi for approximately 200 hours. The nut-and-bolt assemblies were removed and tested once again for breakaway Torque. The results of the experiment are included in Table 1.

TABLE 1
THREADLOCKER ADHESION TEST ON NUT-AND-BOLT ASSEMBLIES

| | | Average | Average Adhesion |
|---|---|---|---|
| | | Adhesion After | After 200 Hours Water |
| | | Full Cure | Soak, 220° C., 405 psi, |
| Formula | Primer | TORQUE, Nm | TORQUE, Nm |
| Loctite 272 | Loctite 7471 | 28.38 ± 6.42 | 0 |
| Threadlocker | | | |
| Loctite 272 | Loctie 7649 | 28.50 ± 10.75 | 0 |
| Threadlocker | | | |
| Formula-A | 10% Co(acac) | 14.58 ± 3.74 | 10.50 ± 2.57 |
| Formula-A | Loctite 7471 | 2.43 ± 0.57 | 6.43 ± 1.66 |
| Formula-B | 10% Co(acac) | 22.53 ± 3.07 | 13.50 ± 3.39 |
| Formula-B | Loctite 7471 | 5.23 ± 2.03 | 11.63 ± 5.66 |
| Formula-B | 5% Cu(Methacrylate) | 19.4 ± 0.3 | 7.7 ± 2.6 |
| Formula-B + 10% | 5% Cu(Methacrylate) | 18.0 ± 0.0 | 15.3 ± 2.1 |
| Ricon130MA13 | | | |
| Formula-C | 10% Co(acac) | 18.38 ± 0.64 | 18.63 ± 2.66 |
| Formula-C | 5% Cu(Methacrylate) | 22.75 ± 2.54 | 18.40 ± 1.91 |
| Formula-C + 10% | 5% Cu(Methacrylate) | 21.80 ± 0.0 | 23.2 ± 0.7 |
| Ricon130MA13 | | | |
| Formula-C | 10% Cu(Methacrylate) | 21.60 ± 1.31 | 14.25 ± 3.64 |
| Formula-C | Loctite 7471 | 0.30 ± 0.48 | 17.18 ± 2.91 |

### Example 3

### Diethyl-p-toluidine salt of saccharin

N,N-Diethyl-p-toluidine (3 moles), saccharin (3 moles), and ethanol (1500 mL) into a flask. The solution was refluxed for an hour. It was allowed to cool to room temperature. Ethanol was removed via rotary evaporation at 70° C. It was removed from the flask and allowed to dry in the oven at 40-45° C. It was packaged in a plastic container. The salt was produced in order to keep the accelerator more soluble in the resin system.

### Example 4

### PTL-29 Threadlocker Primer

The primer consists of 5% Cu Methacrylate in a 60% Acetone/40% IPA solvent blend. The components of the primer were added to a plastic container and shaken until the Copper Methacrylate dissolved. They were packaged into glass bottles. The primer solution (2 to 3 drops) is applied to the entire surface of the thread areas to be locked on both the male and female part. The parts are allowed to dry in air for about 10 minutes.

### Example 5

### Applying the Threadlocker

The Threadlocker formula was stirred with a non-metal spatula, using a disposable pipette two drops of the formula were placed on the thread section to be locked on the male part, followed by assembly of the male and female parts and hand tightened. The parts were allowed to stand at room temperature (50% of full strength in 24 hours, 90% of full strength in 48 hours). The parts were subsequently immersed in a Parr reactor filled with deionized water at a temperature of approximately 220° C. and a pressure of 400 psi for up to 200 hours.

Table 1 shows the results of the adhesion experiment. It is clear to see that although the Loctite threadlocker does have superior adhesion after cure, the adhesion of the material drops down to zero after exposure to high temperature, pressure and aqueous environment. It is also clear from the results that the invention anaerobic adhesives retain adhesion even exposure to the harsh environment. The resin system containing UX-BMI along with 10% Ricon130MA 13 (DMI Threadlocker-230) was shown to have the best adhesion before and after exposure to high temperature moist environment.

DMI TL-230 was found to have a breakaway Torque average of 26.5 Nm at room temperature. The material was also tested while the parts were heated to a temperature of 180° C. and were found to have an average breakaway Torque of 20.6 Nm, retention of 77.6% of the initial strength at high temperature is very remarkable.

The DMI TL-230 was also tested on nut and bolt assemblies composed of standard steel and stainless steel for comparison. The average initial breakaway Torque for standard steel was found to be 22.70±3.32 Nm and after heat aging in water the breakaway Torque was found to be 19.25±5.24 Nm. For stainless steel assemblies the average initial breakaway Torque was found to be 23.25±1.61 Nm and the average breakaway Torque after heat aging in water was found to be 11.15±2.14 Nm.

What we claim is:

1. An anaerobic adhesive composition, which maintains adhesion and demonstrates resistance to hydrolytic degradation at elevated temperatures and pressures, comprising:
(a) at least one hydrophobic ethylenically unsaturated free-radical curable resin;
(b) at least one free-radical initiator;
(c) at least one cure accelerator;
(d) at least one curable acidic component;
(e) and a primer.

2. The said composition of claim 1, wherein the hydrophobic ethylenically unsaturated resin has a heteroatom content of less than 25% based on the total molecular weight of the resin.

3. The said composition of claim 1, wherein the hydrophobic ethylenically unsaturated resin is present within the range from 20.1% to about 99% by weight of the composition.

4. The said composition of claim 2, wherein the ethylenically unsaturated resin is a bismaleimide of unsaturated C-36 dimer diamine.

5. The said composition of claim 2, wherein the ethylenically unsaturated resin is a bismaleimide of hydrogenated C-36 dimer diamine.

6. The said composition of claim 2, wherein the ethylenically unsaturated resin is a polyester acrylate-methacrylate.

7. The said composition of claim 2, wherein the ethylenically unsaturated resin is a curable functionalized polyimide.

8. The said composition of claim 2, wherein the ethylenically unsaturated resin is a polybutadiene (meth)acrylate.

9. The composition of claim 1, wherein the free-radical initiator is selected from the group consisting of cumene hydroperoxide, t-butyl hydroperoxide, p-methane hydroperoxide, diisopropylbenzene hydroperoxide, pinene hydroperoxide, methyl ethyl ketone hydroperoxide and combinations thereof.

10. The composition of claim 1, wherein the free-radical initiator is present within the range of 0.1% to about 10% based on the total weight of the composition.

11. The composition of claim 1, wherein the cure accelerator is selected from the group consisting of saccharin, N,N-diethyl-p-toluidine, N,N-dimethyl-p-toluidine, p-tolyldiethanolamine, 1-acetyl-2-phenylhydrazine, 1,2,3,4-tetrahydroquinoline, 6-methyl-1,2,3,4-tetrahydroquinoline, 1,2,3,4-tetrahydroquinaldine, cinnamaldehyde, dialkylureas and combinations thereof.

12. The composition of claim 1, wherein the cure accelerator is present within the range of about 0.1% to about 10% based on the total weight of the composition.

13. The composition of claim L, wherein the curable acidic component is selected from the group consisting of maleic anhydride, itaconic anhydride, maleimidocaproic acid, maleimidoundecanoic acid, maleimidobutanoic acid, maleimidoproanoic acid, acrylic acid, methacrylic acid, 10-methacryloxydecyl dihydrogen phosphate, 2-methacryloxyethyl dihydrogen phosphate, 6-methacryloxyhexyl dihydrogen phosphate, maleated polybutadiene and combinations thereof.

14. The composition of claim 1, wherein the curable acidic component is present within the range of about 0.1% to about 20% based on the total weight of the composition.

15. The composition of claim 1, wherein the primer is selected from the group consisting of carboxylic acid or phosphate salts of iron, copper, cobalt, manganese, chromium, and combinations thereof.

16. The composition of claim 1, wherein the composition is used as a threadlocking adhesive to prevent loosening of nut and bolt or pipe assemblies.

17. The composition of claim 1, wherein the composition is used as a retaining compound for rigid non-threaded cylindrical assemblies.

18. The composition of claim 1, wherein the composition is used as gasketing materials for use as formed-in-place gaskets that produce leak-proof seals between mating flanges, preventing leakage of moisture, gasses, fluids or contaminants.

19. The composition of claim 1, wherein the composition is a fluid, flowable material.

20. The composition of claim 1, wherein the composition is a non-flowable paste or film.
